(19) United States
(12) Patent Application Publication
(10) Pub. No.: US 2024/0075453 A1
(43) Pub. Date: Mar. 7, 2024

(54) SELECTIVE CARBON BINDING ON CARBON QUANTUM DOTS

(71) Applicant: University of Tennessee Research Foundation, Knoxville, TN (US)

(72) Inventors: Michael Broud, Charlotte, NC (US); David P. Harper, Maryville, TN (US); David Keffer, Knoxville, TN (US)

(73) Assignee: University of Tennessee Research Foundation, Knoxville, TN (US)

(21) Appl. No.: 18/243,215

(22) Filed: Sep. 7, 2023

Related U.S. Application Data
(60) Provisional application No. 63/404,303, filed on Sep. 7, 2022.

(51) Int. Cl. B01J 20/20; B01J 20/22; B01J 20/28; C01B 32/15

(52) U.S. Cl. CPC B01J 20/205; B01J 20/22; B01J 20/28007; B01J 20/28016; C01B 32/15; C01P 2002/54; C01P 2004/64; C01P 2006/60

(57) ABSTRACT

Carbon quantum dots having selected adsorption of carbon dioxide over nitrogen and oxygen can be prepared by amine modification or nitrogen doping of hydrocarbon-based carbon quantum dots. The carbon quantum dots can be used in various applications for the adsorption of carbon dioxide from the atmosphere and for treating industrial processes that generate carbon dioxide. The carbon quantum dots can be synthesized from lignin and can be paired with a porous activated carbon surface to create a renewable composite material with increased selective adsorption of carbon dioxide.

### RELATED APPLICATIONS

This patent application claims the benefit of U.S. Provisional Application 63/404,303, filed on Sep. 7, 2022, the disclosure of which is incorporated by reference.

### STATEMENT REGARDING FEDERALLY SPONSORED RESEARCH

This invention was made with government support under grant number 13390059, awarded by the United States Department of Agriculture. The government has certain rights in the invention.

### COLOR DRAWINGS

The patent application contains color drawings. Copies of this patent or patent application publication with color drawing(s) will be provided by the Office upon request and payment of the necessary fee.

### TECHNICAL FIELD

This application relates to the development and use of carbon quantum dots for capturing and binding carbon dioxide.

### BACKGROUND

Mitigating the effects of climate change requires carbon management on a global scale. Currently, there is a range of research efforts to develop viable carbon capture technologies based on preventing the release of CO₂ from fossil fuel power plants and other combustion processes. While there are several reasons for slow adoption, cost remains the primary deterrent. The materials used for carbon capture must be appropriate for the global application in terms of price, scale, and storage capacity of CO₂, feedstock availability, and ability to regenerate the media with low energy inputs.

Basic carbon capture methods include liquid absorption, membrane absorption, and reaction-based absorption, such as chemical looping. Recent research has focused on absorption, as the other forms of capture have a high cost, energy, and safety issues. Carbon absorption materials, however, show promise in that they can address them. Promising absorption materials include activated carbons, carbon nanomaterials, metal-organic frameworks, alkali metal oxides, and functionalized TiO₂ nanotubes. Even with all of the demonstrated promise, there are drawbacks to adsorbent materials. Notably, impurities commonly degrade and reduce the effectiveness of the adsorbents.

Activated carbon (AC) and composite carbon materials have shown promise for CO₂ capture. Carbon-based materials have a high resistance to heat, moisture, and overall chemical stability. AC can be produced from biomass, such as lignin, coconut shells, and wood, offering a cheap feedstock. Materials with nanoscale structures are essential contributors to advancements in carbon capture. Examples of these nanomaterials include N doping and adding amine groups in silica nanotubes. Carbon-based nanomaterials have proven to be an effective carbon capture material, including the use of nanotubes and graphene. Both graphene and carbon nanotubes can be doped with different functional groups to affect CO₂ adsorption.

Physisorption is an attractive mechanism for CO₂ sequestration because of the ease in regenerating the adsorbent through known pressure-swing or temperature-swing adsorption processes. These processes can be limited by their selectivity and capacity. Coulombic interactions between the adsorbate and adsorbent can play a significant role in physisorption. Atmospheric gases possess very different quadrupole moments, which can be exploited by tailoring the adsorbent's charge distribution. For example, the selectivity of N₂ over O₂ in many zeolites is well established. Commercially, these materials are used for air separation. These materials preconcentrate oxygen before energy-intensive cryogenic distillation. At the atomic scale, the origin of the selectivity lies in the charge distribution of the adsorbent and its interaction with the quadrupole moments of N₂ and O₂. Proven use at an industrial scale confirms the ability to exploit the quadrupole moments of gases for separation through the design of the charge distribution of the adsorbate.

### SUMMARY

The present disclosure is directed to carbon quantum dots (CQDs) which can be used to decorate the interior pore space of model carbon surfaces to achieve selective carbon dioxide adsorption from gas mixtures. Classical molecular dynamics (MD) simulation is used to evaluate the effect of CQD size and composition on the selectivity of CO₂ relative to N₂ and O₂. The CQDs can be initially synthesized from lignin. The CQDs can be modified either through nitrogen doping of the interior hydrocarbon structure or functionalization of the edges with amine groups. The CQDs show selective adsorption for CO₂ relative to N₂ and O₂. The magnitude of the selectivity is a function of CQD size and the amount of doping and functionalization. In accordance with this disclosure, a maximum CO₂:N₂ selectivity of 2.7 and CO₂:O₂ selectivity of 2.2 were obtained on isolated CQDs at 300 K without structural optimization. This disclosure sets the framework for optimizing the CQD atomic architecture on a CQD/AC (activated carbon) adsorbent.

The CQDs can have a hydrocarbon (suitably aromatic) base structure. The base structure can, for example, include one or more of naphthalene, phenanthrene, pyrene, anthanthrene, coronene, and ovalene. The CQDs can have a planar base structure and can have a large base structure having a dimension of at least about 3 nm in at least one direction. The larger base molecules and/or base structure enable the attachment of higher amounts of amine groups and/or nitrogen, which in turn enables individual CQDs to adsorb higher amounts of carbon dioxide.

In one embodiment, the CQDs can have an aromatic base structure and can be amine functionalized. These CQDs can have at least two amine groups attached to the structure, or at least three amine groups attached to the structure, or at least four amine groups attached to the structure. In one embodiment, the CQDs can have from two to four amine groups attached to the structure, and the amine groups can be attached to the edges of the planar hydrocarbon (suitably aromatic) structure.

In one embodiment, the CQDs can have an aromatic base structure and can be modified by doping with nitrogen. The nitrogen doped CQDs can include at least two nitrogen atoms attached to the structure, or at least four nitrogen atoms attached to the structure, or at least six nitrogen atoms attached to the structure, or at least eight nitrogen atoms attached to the structure. In one embodiment, the CQDs can have from two to eight nitrogen atoms attached to the overall hydrocarbon (suitably aromatic) structure.

In one embodiment, the CQDs can be functionalized via amine modification and/or nitrogen doping at a temperature of about 200 K to about 600 K, or about 250 K to about 400 K, or about 300 K, for a time sufficient to achieve reaction equilibrium. When the CQDs are functionalized at the lower temperatures, both the adsorption of all the gases and the adsorption selectivity of carbon dioxide can decrease due to the reduced energy input. When the CQDs are functionalized at higher temperatures above about 300 K, the adsorption and selectivity also decrease due to the increasing role played by entropy in the distribution of the gases between the adsorbed and gas phases.

When the unmodified CQDs are functionalized with amine groups at about 300 K, the resulting CQDs can have an adsorption selectivity of carbon dioxide over nitrogen of at least about 1.5, or at least about 2.0, or at least about 2.5, or about 1.5 to about 3.0, or about 2.0 to about 2.7. These resulting CQDs can have an adsorption selectivity of carbon dioxide over oxygen of at least about 1.5, or at least about 1.8, or at least about 2.0, or about 1.5 to about 2.5, or about 1.8 to about 2.2. When the unmodified CQDs are functionalized using nitrogen doping at about 300 K, the resulting CQDs can have an adsorption selectivity of carbon dioxide over nitrogen of at least about 1.2, or at least about 1.4, or at least about 2.0, or about 1.2 to about 3.0, or about 1.4 to about 2.4. These resulting CQDs can have an adsorption selectivity of carbon dioxide over oxygen of at least about 1.2, or at least about 1.3, or at least about 1.7, or about 1.2 to about 2.5, or about 1.3 to about 2.1.

The unmodified CQDs (prior to amine functionalization and/or nitrogen doping) can be prepared from lignin using a variety of known techniques. Lignin is a class of polyaromatic compounds that includes about 25% of lignocellulosic biomass plant cell wall. It is the second most abundant natural polymer in the world and millions of tons are produced annually as a coproduct of pulp and paper production. Lignin is a highly branched heterogeneous polymer built up with phenylpropane units and has a high carbon content (>60 wt. %), which makes it an excellent fuel for pulp production. Lignin can be classified into three broad classes, softwood, hardwood, and herbaceous (grass) lignin, based on their composition in structural units. Softwood has higher lignin content (˜28%) compared with hardwood (˜20%) and grass (˜15%) and is deemed especially suitable for synthesizing CQDs. Kraft softwood pulp is one example of a common and desirable source of lignin.

The unmodified CQDs are typically nanoparticles having a size of <10 nm and a carbon core surface-passivated with various functional groups. The synthesis of CQDs can be divided into top-down and bottom-up main categories. Top-down synthesis involves breaking the larger structures into smaller nano-carbon particles under harsh conditions, and electrochemical etching, chemical oxidation and laser ablation are commonly used methods. Bottom-up synthesis adopts a hydrothermal method, microwave assistance, or ultrasonic treatment to build CQDs from small molecules or polymer precursors.

With the foregoing in mind, it is a feature and advantage of this disclosure to provide carbon quantum dots having selected adsorption of CO₂ over N₂ and O₂, wherein the carbon quantum dots are selected from the group consisting of amine-functionalized carbon quantum dots and nitrogen-doped carbon quantum dots.

It is also a feature and advantage of the disclosure to provide carbon quantum dots having selected adsorption of CO₂ over N₂ and O₂, wherein the carbon quantum dots have an aromatic base structure with at least one of a) from two to four amine groups attached to the structure, and b) from two to eight nitrogen atoms attached to the structure.

It is also a feature and advantage of the disclosure to provide carbon quantum dots derived from lignin, the carbon quantum dots having selected adsorption of CO₂ over N₂ and O₂ and a base structure selected from the group consisting of naphthalene, phenanthrene, pyrene, anthanthrene, coronene, ovalene, and combinations thereof, wherein the carbon quantum dots comprise at least one of a) from two to four amine groups, and b) from two to eight nitrogen atoms.

The foregoing and other features and advantages will become further apparent from the following detailed description, read in conjunction with the accompanying drawings.

### BRIEF DESCRIPTION OF THE DRAWINGS

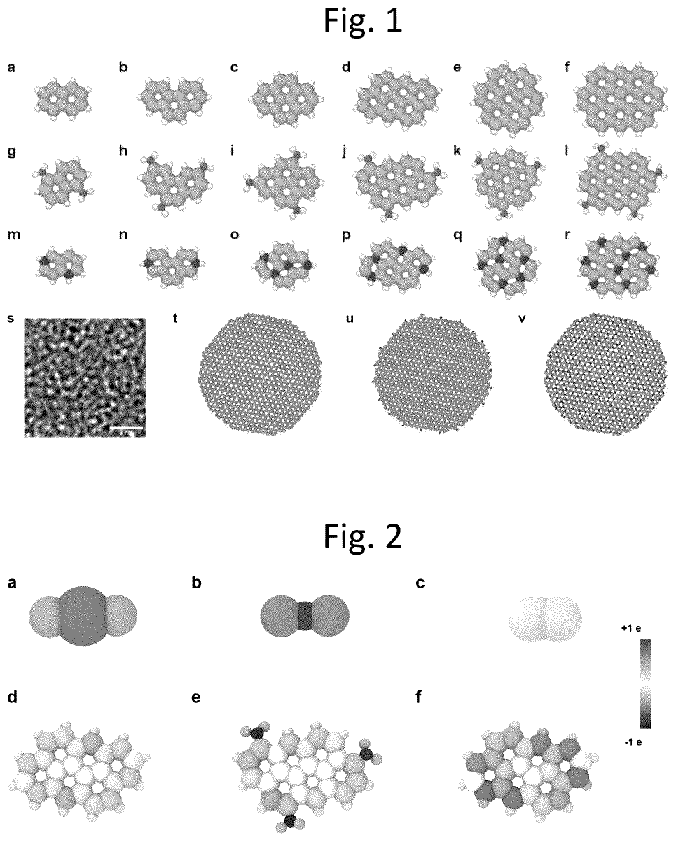

FIG. 1 is a color drawing showing the atomic architecture of the twenty-one CQDs that were investigated. The three categories of planar dots include hydrocarbons (a-f), amine-functionalized (g-l), and N-doped CQDs (m-r). Each category contains seven sizes of CQDs. Color legend: H: white, C: green, N: blue.

FIG. 2 provides color schematics of the charge distribution in the three gases and the CQDs. The relative effective quadrupoles of the three gases scaled to CO₂ are 1.0 for CO₂, 0.34 for N₂ and 0.07 for O₂.

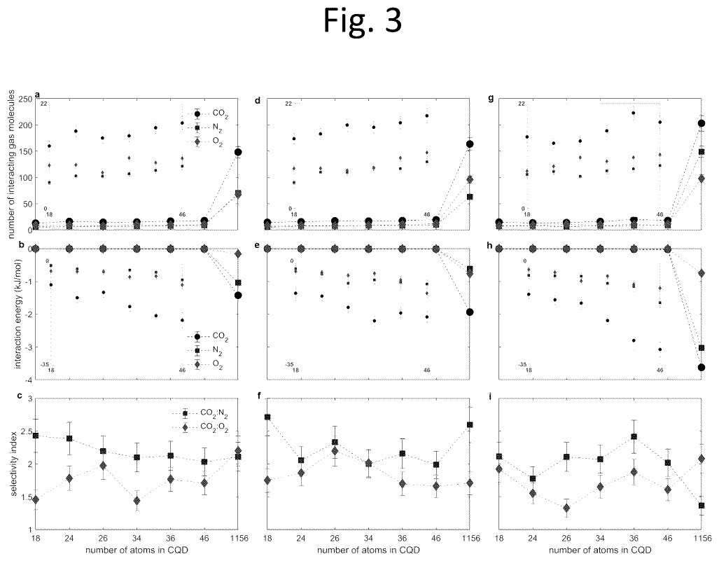

FIG. 3 includes nine color graphs showing the results of simulations with a single component gas on graphite at 300 K. The top row of graphs shows the number of gas molecules interacting with CQD. The middle row shows the total interaction energy of gas molecules with CQD. (The inset has units of J/mol.) The bottom row shows the carbon dioxide selectivity over nitrogen and oxygen. Left column: hydrocarbon CQDs. Middle column: amine functionalized CQDs. Right column: N-doped CQDs.

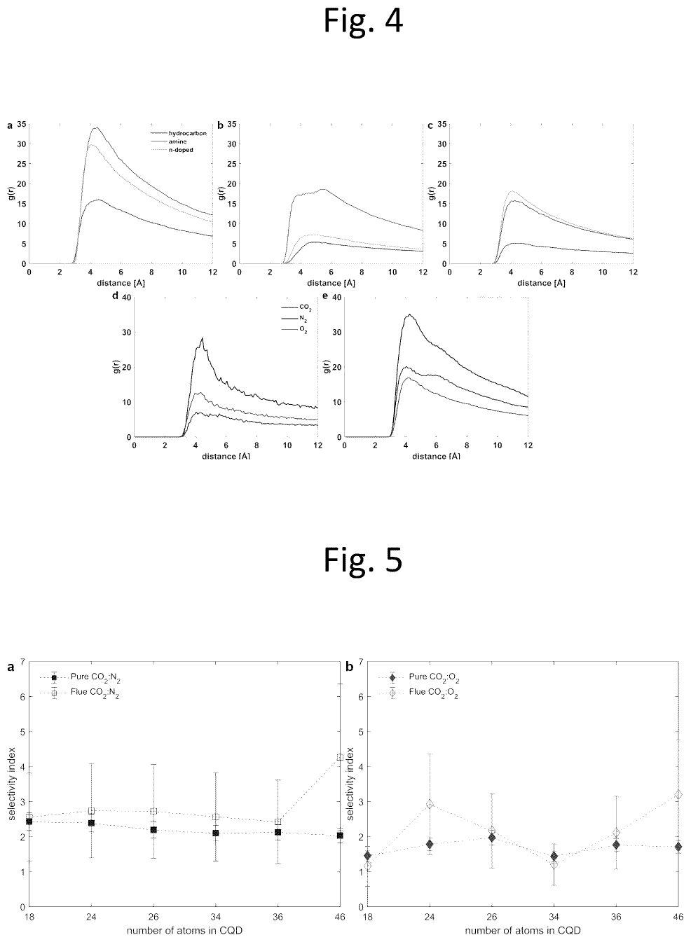

FIG. 4 includes color graphs showing Radial Distribution Functions (RDFs) between C atoms of the CQDs and the midpoint of the gas molecules for (a) CO₂, (b) N₂, and (c) O₂. RDFs between N atoms of the CQDs and the midpoint of the gas molecules are shown for (d) amine functionalized CQDs and (e) N-doped CQDs.

FIG. 5 includes two color graphs showing the selectivity of CO₂ relative to N₂ (right) and O₂ (left).

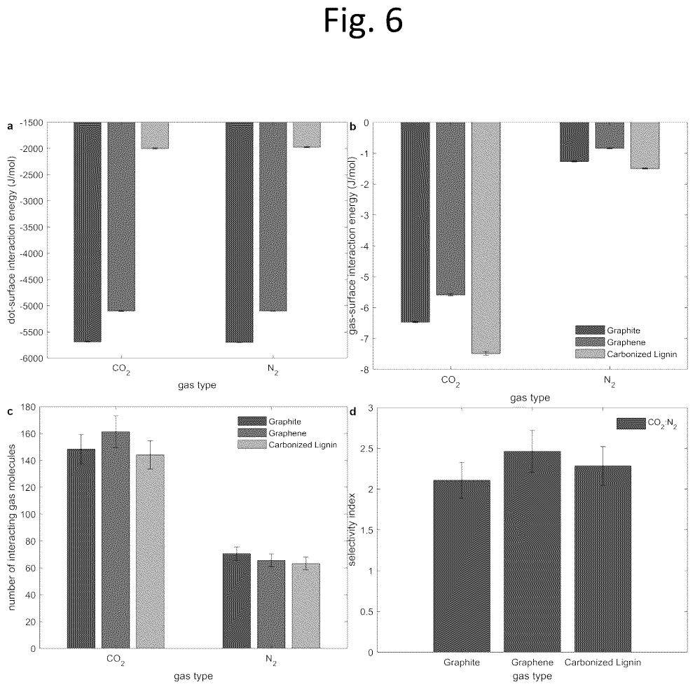

FIG. 6 includes four color graphs (a-d) showing the effects of the substrate surface in a system with the large hydrocarbon CQD at 300 K. They are (a) CQD binding energy as a function of the surface under two gases, (b) total gas interaction energy as a function of the surface, and (c) the number of gas molecules interacting with CQD. (d) Selectivity for CO₂ over N₂.

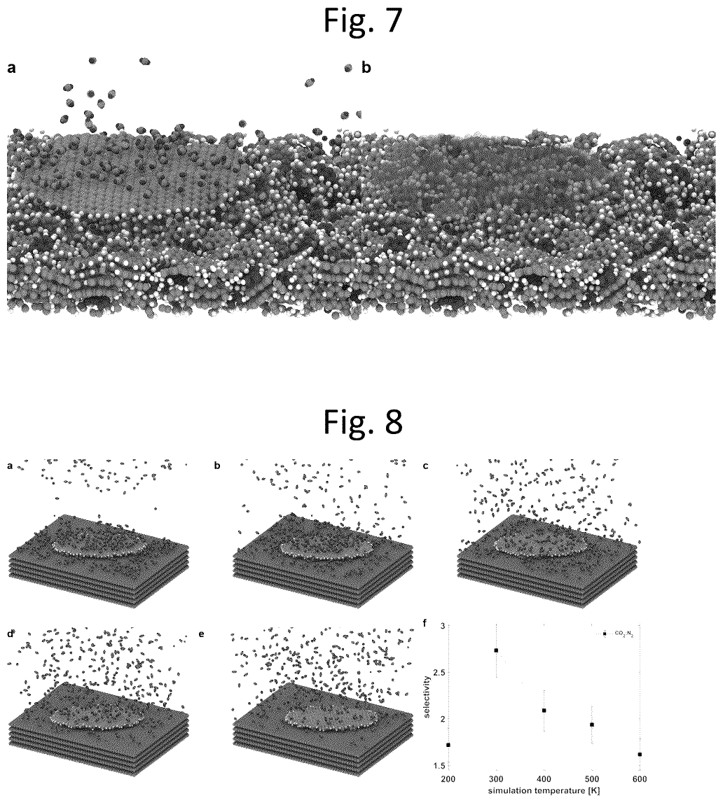

FIG. 7 is a color snapshot of the large hydrocarbon CQD on the LBCC surface exposed to CO₂. In FIG. 7(a), all atoms are opaque. In FIG. 7(b), the CQD atoms have been made transparent, and the CO₂ molecules above the CQD have been removed to show the CO₂ under the CQD.

FIG. 8 includes color diagrams (a-e) and a graph (f) showing the effects of temperature on adsorption and selectivity. FIGS. 8(a) through (e) are snapshots of CO₂ on the large hydrocarbon CQD on graphite at 200, 300, 400, 500 & 600 K, respectively. FIG. 8(f) shows selectivity for CO₂ over N₂ as a function of temperature.

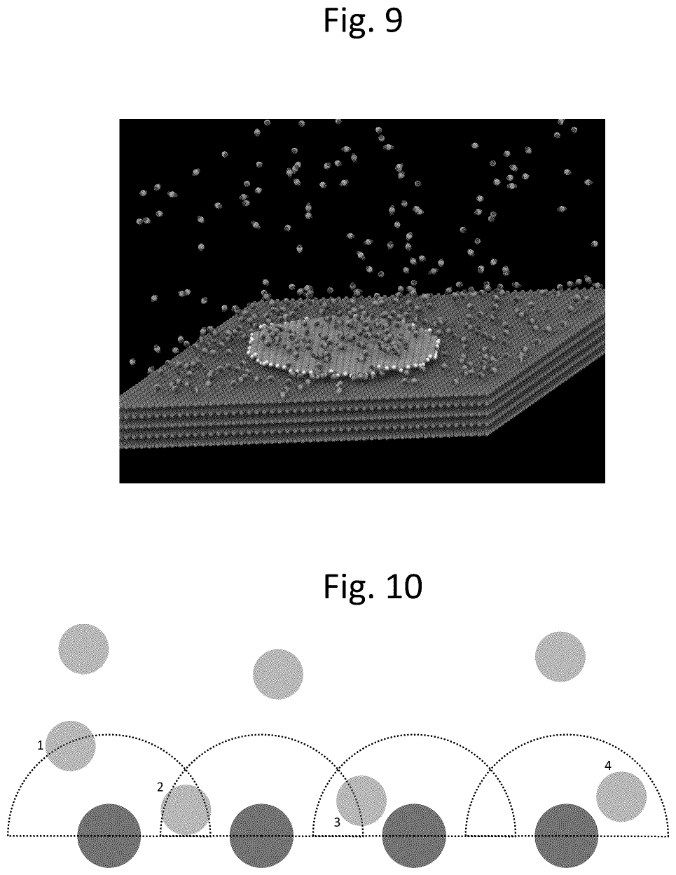

FIG. 9 is a color snapshot of the simulation apparatus used for the experiments.

FIG. 10 is a color schematic representation of how the number of gas molecules interacting with the CQD was calculated. Gray dots represent atoms in the CQDs, while the blue dots represent the center of mass of gas molecules. The dotted lines represent a sphere of a cut-off distance (12 Å here) about each CQD atom. At any moment, a gas molecule with a center of mass within 12 Å of any atom in the CQD is said to be interacting with the CQD. Gas molecules interacting with multiple atoms in the CQD are only counted once. In this illustration, there are four interacting gas molecules.

### DETAILED DESCRIPTION

The following detailed description will illustrate the general principles of the invention, examples of which are additionally illustrated in the accompanying drawings. In the drawings, like references indicate identical or functionally similar elements.

Except in the working examples, or where otherwise explicitly indicated, all numbers in this description indicating amounts, parts, percentages, ratios, and proportions of material, physical properties of material, and conditions of reaction are to be understood as modified by the word “about.” “About” as used herein means that a value is preferably +/−5% or more preferably +/−2%. Percentages for concentrations are typically % by wt. For pH values, “about” means+/−0.2.

This disclosure is directed to carbon quantum dots as descried in the foregoing Summary and recited in the claims. The CQDs are modified with amine functionality and/or by nitrogen doping to instill an improved and preferential adsorption of CO₂ over both N₂ and O₂. The CQDs can be sized and tailored to optimize both the amount of CO₂ adsorption and the selectivity of CO₂ versus N₂ and O₂ adsorptions.

Twenty-one CQDs were modeled for this disclosure. The compositions of the CQDs are provided in Table 1. The atomic architectures of the CQDs are shown in FIG. 1. The CQDs are modeled as aromatic planes. The twenty-one CQDs were divided into three categories described as hydrocarbons (unmodified controls), amine-terminated, and N-doped. Each of the three categories includes seven CQDs with the same number of aromatic atoms, from 10 to 1056. These planes are terminated either with hydrogen (in the case of hydrocarbon and N-doped CQDs) or both hydrogen and amine groups (in the case of the amine-functionalized CQDs).

The color legend for FIG. 1 is as follows: H (white) for hydrogen, C (green) for carbon, and N (blue) for nitrogen. Seven CQDs (a-f) and (t) correspond to an unmodified aromatic hydrocarbon, namely (from left to right): naphthalene, phenanthrene, pyrene, anthanthrene, coronene, and ovalene; and (below) an experimentally synthesized large hydrocarbon having 1056 carbon atoms. Seven CQDs (g-l) and (u) correspond to those same hydrocarbons partially functionalized with amine groups. Seven CQDs (m-r) and (v) correspond to those same hydrocarbons partially doped with N. The three largest CQDs (t-v) correspond to the size (3 nm) of the experimentally synthesized CQD shown in (s).

TABLE 1
Compositions of Carbon Quantum Dots Investigated

| CQD | | hydrocarbon | | amine functionalized | | | N-doped | | |
|---|---|---|---|---|---|---|---|---|---|
| # | base name | # of C | # of H | # of N | # of C | # of H | # of N | # of C | # of H |
| 1 | naphthalene | 10 | 8 | 2 | 10 | 10 | 2 | 8 | 8 |
| 2 | phenanthrene | 14 | 10 | 3 | 14 | 13 | 3 | 11 | 10 |
| 3 | pyrene | 16 | 10 | 3 | 16 | 13 | 4 | 12 | 10 |
| 4 | anthanthrene | 22 | 12 | 4 | 22 | 16 | 5 | 17 | 12 |
| 5 | coronene | 24 | 12 | 4 | 24 | 16 | 6 | 18 | 12 |
| 6 | ovalene | 32 | 14 | 4 | 32 | 18 | 8 | 24 | 14 |
| 7 | large (3 nm) | 1056 | 82 | 21 | 1056 | 103 | 264 | 792 | 82 |

FIG. 2 provides schematics of the charge distributions in the three gases and the CQDs. Additional data on the quadrupoles of the gas molecules are provided in Table 2. The relative effective quadrupoles of the three gases scaled to CO₂ are 1.0 for CO₂, 0.34 for N₂, and 0.07 for O₂. The charges of Interaction potentials for the CQDs were taken from the GROMACS 54A7 force field described below in the description of methods. This forcefield includes intramolecular flexibility of stretching, bending, and torsional modes as well as non-bonded interactions through Lennard-Jones potential and electrostatic interactions based on point charges. Since the large dot was too large for Automated Topology Builder (ATB), −0.12, point charges were assigned to the hydrogens and 0.12 assigned to the carbons bonded to them to make it charge neutral. An example of the charge distributions on the coronene-based CQD for each category is shown in FIG. 2. The addition of nitrogen either as an amine or through doping increases the partial charge distribution. The amine functionalization localizes the strongest charge separation at the edge of the CQD, while N-doping increases charge distribution in the interior of the CQD.

TABLE 2
Charges of the gases used in the simulation.

| | q_{mid} | q_{end} | Bond length | |
|---|---|---|---|---|
| Gas Type | [e] | [e] | [Å] | Q/Q_{CO2} |
| CO₂ | 0.6512 | −0.3256 | 1.149 | 1.00 |
| N₂ | 0.964 | −0.482 | 0.549 | 0.34 |
| O₂ | 0.224 | −0.112 | 0.504 | 0.07 |

FIG. 3 presents the results from simulations containing a single component gas (CO₂, N₂, or O₂) and a graphite surface at 300 K. The figure contains three columns, with the left column based on simulations of hydrocarbon CQDs (unmodified), the middle column corresponding to amine-functionalized CQDs and the right column N-doped CQDs. For each category of CQD, the top row reports the average number of gas molecules interacting with the CQD. The middle row reports the average total interaction energy between gas molecules and CQD. The bottom row reports the selectivity of CO₂ over N₂ and CO₂ over O₂. In all nine subplots, the x-axis corresponds to the total number of atoms in the base hydrocarbon CQD. The x-axis is a nonlinear scale. The error bars represent one standard deviation based on block averaging of the frames of the trajectory using 10 boxes.

FIG. 3(a), shows that the number of CO₂ molecules interacting with the CQD increases with the size of the CQD. This observation is to be expected since a larger dot provides a larger volume for interaction. For the smallest hydrocarbon dot, the number of interacting CO₂, N₂, and O₂ are 13.1, 5.4, and 9.1, respectively. For the largest dot, the number of interacting CO₂, N₂, and O₂ are 148, 70.3, and 67.4, respectively.

The preferential adsorption of CO₂ over N₂ and O₂ can be explained energetically by examining FIG. 3(b), in which the total interaction energy of the gas with the CQD is reported. An interaction energy per molecule could be calculated using the number of interacting molecules reported in FIG. 3(a) and explicitly not the total number of gas molecules in the simulation (400). The magnitude of these interaction energies clearly corresponds to physisorption. In this case, the physisorption appears to be dominated by electrostatic interactions, given the difference in quadrupole moments of CO₂, N₂, and O₂. Interestingly, for the hydrocarbon CQDs, the O₂ is slightly preferred over N₂ despite the larger quadrupole moment of N₂, except at the largest CQD, where the number of adsorbed N₂ and O₂ are similar.

The per molecule binding energy of CO₂ becomes more favorable with increasing CQD size, increasing in magnitude from −0.59 J/mol for the smallest CQD to −7.7 J/mol for the largest CQD. The explanation lies in the charge distribution. The planar dot is terminated by H. Due to the polarity of the covalent C—H bond, the H bears a positive partial charge, and the C bears a negative partial charge. It is this dipole that interacts with the quadrupole of the gas molecule. There is no such dipole in the internal C—C bonds. The number of C—H bonds increases with increasing CQD size. Therefore, the per molecule binding energy becomes important. Referring to FIG. 3(c), the selectivity for CO₂ over N₂ and CO₂ over O₂ in the presence of the hydrocarbon CQDs is shown. The selectivity for CO₂ over N₂ is bound between 2.1 and 2.4 and decreases slightly with increasing CQD size. The selectivity for CO₂ over O₂ is not as pronounced and is bound between 1.5 and 2.2, where the variation with respect to CQD size is non-monotonic. Given the order of relative quadrupoles given in Table 2 and the fact that we observe in many cases more O₂ binding than N₂, we conclude that the modest charge distribution in the hydrocarbon CQDs is not sufficient to induce any separation between N₂ and O₂ based on differences in quadrupole moments.

Turning our attention to the amine functionalized CQDs, a similar trend applies for the number of interacting CO₂ as a function of CQD size in FIG. 3(d), as was seen for the hydrocarbon CQD in FIG. 3(a). Quantitatively, the numbers of interacting CO₂ are higher for the amine functionalized CQD. For the smallest hydrocarbon dot, the number of interacting CO₂ increases from 13 for the hydrocarbon CQD to 15 for the amine functionalized CQD. For the largest dot, the number of interacting CO₂ increases from 148 for the hydrocarbon CQD to 163 for the amine functionalized CQD. For all sizes of CQD, a greater number of CO₂ molecules interact with the CQD compared to N₂ and O₂. Interestingly, the largest amine functionalized CQD interacts with more O₂ (96) than N₂ (63), which contrasts with the largest hydrocarbon CQD, which interacted with a relatively equal number of molecules of both gases (67 and 70).

FIG. 3(f) shows the selectivity for CO₂ over N₂ and CO₂ over O₂ in the presence of the amine functionalized CQDs is reported. The selectivity for CO₂ over N₂ is bound between 2.0 and 2.7. The selectivity for CO₂ over O₂ is not as pronounced and is bound between 1.8 and 2.2. Thus, the amine functionalized CQD represents an increase in selectivity for CO₂ over N₂ compared to the hydrocarbon CQD, but not much difference in selectivity for CO₂ over O₂. In both cases, the variation in the selectivity with respect to CQD size is non-monotonic but within the uncertainty of the error bars.

Examining the N-doped CQDs, a similar trend was observed for the number of interacting molecules as a function of CQD size in FIG. 3(g), as was seen for the hydrocarbon and amine-terminated CQDs in FIGS. 3(a) and 3(d). However, for the largest CQD, the numbers of interacting CO₂ are higher for the N-doped CQD (203) than for either the hydrocarbon CQD (148) or the amine-functionalized CQD (163). For all sizes of CQD, a greater number of CO₂ molecules interact with the CQD compared to N₂ and O₂. Interestingly, the largest N-doped CQD preferentially interacts with N₂ (150) over O₂ (98). This observation is the reverse of the amine functionalized CQD, which preferentially interacted with O₂ (96) over N₂ (63).

The total energy of interaction between gas and N-doped CQD, as shown in FIG. 3(h), again corroborates the trends in the number of interacting molecules. The total binding energy increases in magnitude with increasing CQD size and remains strongest for CO₂. Compared to the hydrocarbon and amine-functionalized CQDs, the degree to which the total interaction energy of the gas with the N-doped CQD becomes more favorable is much more pronounced. The per molecule binding energy of CO₂ with the N-doped CQD increases in magnitude from −0.76 J/mol for the smallest CQD to −18 J/mol for the largest CQD. The argument for why there is stronger binding energy, especially in the large dots, is that the N-doped occurs in the interior of the dot. Thus, more N can be introduced via doping than via amine functionalization based on the surface area-to-volume ratio.

FIG. 3(i) shows the selectivity for CO₂ over N₂ and CO₂ over O₂ in the presence of the amine functionalized CQDs. The selectivity for CO₂ over N₂ is bound between 1.4 and 2.4. The selectivity for CO₂ over O₂ is not as pronounced and is bound between 1.3 and 2.1. Thus, the N-doped CQD represents a decrease in selectivity for CO₂ over N₂ compared to the hydrocarbon CQD, but not much difference in selectivity for CO₂ over O₂.

The local structure of the gases around the CQDs provides insight into the role that the doping atoms or functionalized groups play. FIG. 4 shows Radial Distribution Functions (RDFs) for the gases used in the simulations and the three types of dots corresponding to the largest CQD. The top row shows the RDF between C atoms in the CQDs and the mid-point in the gas molecules, the C atom of CO₂, and the central charge of the quadrupole for N₂ and O₂. For CO₂ and N₂, the RDF shows preferential binding to the amine-functionalized CQD, followed by the N-doped CQD and, lastly, the hydrocarbon CQD. For O₂, the N-doped CQD shows slightly greater aggregation than the amine-functionalized CQD. Two peaks are evident in the RDF for N₂ and the amine functionalized CQD.

In FIGS. 4(d) and (e), the RDF of midpoint gas and the N atoms in the amine-functionalized CQD (d) and the N-doped CQD (e) are shown. Both types of CQDs favor the strongest aggregation of CO₂. The amine functionalized CQD preferentially attracts O₂ over N₂, while the N-doped CQD preferentially attracts N₂ over O₂. Clear second peaks are seen at about 6 Å for CO₂ and N₂ in the presence of the N-doped CQD. In comparing the CO₂ RDFs between the C and N atoms of the amine functionalized CQD, we observe greater CO₂ aggregation around the C atoms. However, we observe greater CO₂ binding around the N atoms of the N-doped CQD. For N₂, the difference is stark. N₂ greatly prefers to associate around the C atoms in the amine functionalized CQD but strongly prefers to associate around the N atoms in the N-doped CQD. O₂ shows a weak preference for C atoms in the amine functionalized and N-doped CQDs.

The observations made from the RDFs are consistent with the number of gas molecules interacting with the CQDs and energies of interaction between gas and CQD shown in FIG. 3 and are most evident for the largest CQDs. The presence of N in the N-doped CQDs is responsible for the increased N₂ adsorption. Incorporating N into the CQD via amine groups does not induce the same effect. The effect on the selectivity shown in FIG. 3, is a result of selectivity being a ratio of the numbers of associated gas molecules. The increase in the CO₂:N₂ selectivity in the presence of the amine functionalized CQD and the decrease in CO₂:N₂ selectivity with the N-doped CQD can be traced through the RDFs to the different interaction of the gas molecules with the N atoms in the CQD.

The selectivity of hydrocarbon CQDs was also investigated by simulating a dry flue gas with a composition of 84% N₂, 12% CO₂, and 4% O₂ using a graphite substrate at 300 K. FIG. 5 shows the resulting selectivity for CO₂ from those simulations for (a) N₂ and (b) O₂. Also included in the plots are the selectivities obtained from the single component simulations. The selectivities from the flue gas simulations are higher than that of the pure gas simulations. CO₂:N₂ selectivity was, on average, 12% higher compared to the pure gas simulations and 8.1% higher for CO₂:O₂. CO₂ selectivity in the flue gas is higher because, in a mixture, N₂ and O₂ bind less strongly than CO₂ and therefore are more easily displaced from the adsorbed phase to the gas phase. In other words, it is easier for CO₂ to compete with N₂ and O₂ than with itself.

In order to determine the effect of the substrate on selectivity, three different substrate surfaces were investigated: graphite, graphene, and a lignin-based carbon composite surface (LBCC). The LBCC surface was composed of graphitic nanocrystallites and a disordered amorphous carbon domain. There are two qualitative differences in these surfaces: roughness and charge. The graphite and graphene (single graphite sheet) surfaces are atomically smooth and uncharged. The LBCC surface was, by comparison, rough and possesses partial charges due to the presence of hydrogen, terminating both the graphitic nanocrystallites and the amorphous carbon fragments. The simulations of the graphene and LBCC surface were performed for only one CQD, the largest hydrocarbon CQD. The simulations were performed for single component CO₂ and N₂ gases at 300 K.

FIG. 6 compares the results from the different surface simulations for the largest hydrocarbon dot exposed to CO₂ and N₂. In FIG. 6(a), the interaction energy between the CQD and the surfaces is reported under both CO₂ and N₂. The binding energy is strongest for graphite. The graphene binding energy is weaker because the attractive interaction due to the underlying carbon layers in graphite is now absent. The LBCC binding energy is weakest due to the roughness of the surface. The CQD binding energies range from −5.7 to −2.0 kJ/mol and are not impacted by the gas present.

In FIG. 6(b), the interaction energy between the gases and the surfaces is shown. The binding energy is strongest for the LBCC surface. The presence of the charge distribution in the LBCC interacts with the quadrupoles in the gas molecules. The larger CQD could not adjust its configuration to achieve favorable electrostatic interactions in the same way that the much smaller gas molecules do.

In FIG. 6(c), the number of gas molecules interacting with the CQD on each surface is shown. These numbers are the same within statistical accuracy for all three surfaces. In FIG. 6(d), the selectivity of the CQD for CO₂ over N₂ is shown for all three surfaces. Again, this selectivity is the same for all three surfaces within statistical accuracy, falling within 2.1 to 2.5. Based on these simulations, we anticipate that the choice of carbon substrate will not strongly affect the selectivity of the CQDs for CO₂.

The roughness of the LBCC surface had two additional effects not visible in FIG. 6 but shown in FIG. 7. While for all surfaces, desorption of the CQD from the surface was not observed, the simulations involving graphite and graphene revealed that the CQD randomly slid across the surface. No such self-diffusion took place on the LBCC surface where the CQD was anchored in place. Second, due to the roughness of the activated carbon surface, gas molecules can be seen in FIG. 7 going underneath the CQD, a phenomenon that was not seen with the two smooth surfaces.

Because the binding mechanism is energetically based, the adsorption of all species should decrease with temperature and the selectivity for the more strongly binding species (CO₂) should also decrease with temperature. Simulations of the large hydrocarbon CQD on the graphite surface under both CO₂ and N₂ for a range of temperatures from 200 K to 600 K were performed. In FIGS. 8(a) through 8(e), snapshots confirm the reduction in the number of adsorbed CO₂ as a function of increasing temperature. From 300 K to 600 K, the selectivity of the CQD decreased due to the increasing role that entropy plays in the distribution of the gas between the adsorbed and gas phases. At 200 K, a reduction in selectivity was observed due to condensation on the surface.

The foregoing embodiments demonstrate that materials derived from lignin make excellent candidates for carbon sequestration due to adsorptive properties, thermal and mechanical stability, low cost, abundance, and sustainability. Lignin-based activated carbon materials decorated with CQDs provide a competitive potential to be a large-scale carbon adsorbent. The MD simulations demonstrated the selectivity that hydrocarbon, amine-functionalized and N-doped CQDs have for CO₂ over N₂ and O₂. CO₂ preferentially interacts with the CQDs compared to the other gases. The highest selectivity observed at 300 K was 2.71 and 2.20 for CO₂:N₂ and CO₂:O₂, respectively. Charge distribution can be manipulated in CQDs to influence selectivity. Through optimization of the charge distribution, CQDs have the potential to become viable candidates for global-scale carbon sequestration.

Methods

As explained above, twenty-one CQDs were modeled having compositions provided in Table 1 and atomic architectures shown in FIG. 1. The CQDs were modeled as aromatic planes and divided into three categories described as hydrocarbons, amine-terminated, and N-doped. Each of the three categories included seven CQDs with the same number of aromatic atoms, from 10 to 1056. The aromatic planes were terminated either with hydrogen (in the case of hydrocarbon and N-doped CQDs) or both hydrogen and amine groups (in the case of the amine-functionalized CQDs). The interaction potential for the CQDs was taken from the GROMACS 54A7 force field. The forcefield included intramolecular flexibility of stretching, bending, and torsional modes as well as non-bonded interactions through Lennard-Jones potential and electrostatic interactions based on point charges. Since the large dot was too large for Automated Topology Builder (ATB), −0.12, point charges were assigned to the hydrogens and 0.12 assigned to the carbons bonded to them to make it charge neutral. An example of the charge distributions on the coronene-based CQD for each category is shown in FIG. 2. The addition of nitrogen either as an amine or through doping increased the partial charge distribution. The amine functionalization localized the strongest charge separation at the edge of the CQD, while N-doping increased charge distribution in the interior of the CQD.

Four gas systems were used in the simulation. Three pure gas systems of CO₂, N₂, and O₂ were simulated. Additionally, a dry flue gas that consisted of a mixture of the three gases with a composition of 84% N₂, 12% CO₂, and 4% O₂ was simulated. In each simulation, 400 (or 300, see below) gas molecules were included. The interaction potentials for N₂, CO₂, and O₂ were all taken from the same source. Each molecule is internally rigid with three-point charges. For CO₂, the point charges are located on the atoms, while for the diatomic molecules, there is an additional point charge in the center. The charges and their resulting quadrupole moment are reported in Table 2. FIG. 2 shows the charge distribution in each of the gases. The traceless quadrupole tensor components were calculated as

$${Q}_{i j} = {\sum }_{k} {q}_{k} ( 3 {r}_{i k} {r}_{j k} - {‖ \vec{{r}_{k}} ‖}^{2} {δ}_{i j} ) \qquad ( 1 )$$

The effective quadrupole, Q, was calculated as

Q²=⅔(Qₓₓ²+Q_{yy}²+Q_{zz}²) (2)

In practice, the CQDs can be deposited on the interior pore space of a porous activated carbon substrate. In the foregoing examples, three model carbon substrate surfaces were investigated. The first surface was a graphite surface. The surface contained five layers of graphite in the z-dimension and n unit cells along the x-axis and m unit cells along the y-axis. The second surface is a sheet of graphene. The third surface was an atomistic model of a lignin-based carbon composite composed of graphitic nanocrystalline and amorphous carbon domains. The crystal structure of graphite and the lignin carbon composite were taken from the literature. Details of the three surfaces were provided and stated in Table 3.

TABLE 3
Surface name, number of each atom type, surface area, and the
number of gas molecules in the atmosphere for each surface.

| | | | | Surface | Atmospheric | |
|---|---|---|---|---|---|---|
| | | | | Area | Volume | # of gas |
| Surface | # of Cs | # of Hs | Total | [nm²] | [nm³] | molecules |
| graphite | 25,250 | 0 | 25,250 | 141.1 | 1552 | 400 |
| graphene | 5,050 | 0 | 5,050 | 141.1 | 1552 | 400 |
| activated | 10,766 | 6,611 | 17,377 | 100.0 | 1149 | 300 |
| carbon | | | | | | |

Graphite was used as the primary surface unless otherwise stated. Simulations on graphene and lignin were included to assess the impact of the substrate on selectivity and were only included for two types of CQDs and two gases. For all surfaces, the atoms composing the substrate were held rigid. The interaction potentials for graphite and graphene were ε=0.06554 kcal mol⁻¹ and σ=3.4 Å. Because the activated carbon surface had an amorphous and crystal carbon structure, the potential from graphite was used for the crystalline sections, and the carbon potential used from the GROMACS 54A7 force field was used for the amorphous sections. The hydrogen potential was taken from GROMACS 54A7. The graphite and graphene surfaces are uncharged. The carbon composite surface had charges and potentials consistent with GROMACS 54A7. Charges were assigned using the same method as the large hydrocarbon dots.

Each simulation included gas molecules, a single CQD, and a substrate. The area in the x-y plane for the graphite and graphene is a parallelogram, and that for the lignin composite is a square. The surface area and volume of the simulation atmosphere are reported in Table 3. Due to the smaller atmospheric volume for the carbon composite simulations, the number of gas molecules was scaled to keep the number of molecules per volume the same. This definition of the system provides a constant volume for the system rather than constant pressure. The system was not periodic in the z-dimension (normal to the surface). Any density fluctuation of the gas phase at the fixed top boundary is sufficiently far from the surface to not directly impact the adsorbed phase.

Several software applications were used to build the CQDs for simulation. Avogadro was used to construct the primary coordinates of the CQDs. The CDQs were run through Visual Molecular Dynamics (VMD) using TOPO tools to generate basic connectivity information. Connectivity and atom positions were supplied to ATB to generate potential parameters, including charge distribution, for the CQDs. Using Moltemplate, the output from ATB is converted into configuration files.

Individual LAMMPS configuration files for all twenty-one CQDs, the four gases, and the three surfaces were generated. The LAMMPS “append” command was used to combine the dot, surface, and gas into one simulation. This allowed for quick, automated combinations of CQD, gas, and surface. A configuration can be seen in FIG. 9.

Classical Molecular Dynamics (MD) simulation was used to model the dynamic behavior of gases and CQDs in the presence of a surface. The simulations were conducted in the canonical (NVT) ensemble using the Large-scale Atomic/Molecular Massively Parallel Simulator (LAMMPS.

A total of 100 simulations were run with different combinations of CQDs, gases, surfaces, and temperatures. Most of the simulations were run at 300 K. Several more simulations were run at 200 K, 400 K, 500 K, and 600K to confirm the expected temperature dependence of selectivity. Simulations were run for 500,000 steps with a time step of 1 fs. The cut-off value for all interaction potentials was 12 Å. The long-range electrostatic contribution to the potential was evaluated using the Ewald method. The r-Respa integrator was used with intramolecular modes (bond, angle, dihedral, and improper torsion) evaluated at ⅛, ¼, ½, and ½ the base time step, respectively. The Nosé-Hoover thermostat was used to control the temperature. The first 250,000 steps were used to equilibrate the system and were not included in data production. Trajectories were saved every 1,000 steps.

The MD simulations produced a variety of thermodynamic and structural information. It is a straightforward matter to compute the total interaction energy between any two components (CQD, gas, surface). Since the CQD remains bound to the surface, the interaction energy between the CQD and the surface corresponds to the binding energy. The gas molecules distributed across a gas phase and a bulk phase, and there was a continuous exchange between the two phases. Therefore, calculating an estimate of the binding energy of the gas, the number of bound gas molecules, and the selectivity must be clearly defined. Following a procedure analogous to that used for the CQD/surface, namely the total interaction energy between all gas molecules and the CQD, provides quantifiable potential energy that includes the fact that any gas atoms beyond the cut-off distance do not contribute to this potential energy. We can also define the number of gas molecules bound to the CQD as any molecule in which the center-of-mass was located within the cut-off distance (12 Å in these examples) of any atom in the CQD. FIG. 9 shows the method that was used to determine the number of interacting molecules with the CQDs. This instantaneous number of atoms was determined post-simulation from the trajectory files and averaged over saved frames after equilibration is complete.

FIG. 9 illustrates how the number of gas molecules interacting with the CQD was calculated. Gray dots represent atoms in the CQDs, while the blue dots represent the center of mass of gas molecules. The dotted lines represent a sphere of a cut-off distance (12 Å here) about each CQD atom. At any moment, a gas molecule with a center of mass within 12 Å of any atom in the CQD is said to be interacting with the CQD. Gas molecules interacting with multiple atoms in the CQD are only counted once. In this illustration, there are four interacting gas molecules.

Selectivity was estimated as a ratio of the number of gas molecules interacting with the CQD.

$${S}_{A : B} = \frac{{N}_{A}}{{N}_{B}} \qquad ( 3 )$$

Selectivity of CO₂ to N₂, therefore, can be calculated from pure component simulations of CO₂ to N₂, in which the number of CO₂ and N₂ interacting with the CQD was determined. The analogous statement is true of the selectivity of CO₂ to O₂.

Selectivity was also estimated from simulations with a gas mixture. In this case, equation (3) was used again, but the number of CO₂ and N₂ interacting with the CQD was determined from the same simulation. The selectivity for CO₂ is always higher when computed from mixture simulations than when computed from single component simulations because, in the pure component case, CO₂ is partitioning between the gas and adsorbed phase, while in the mixture case, the less strongly bound species can preferentially remain in the gas phase, allowing a comparatively greater number of CO₂ to adsorb.

The embodiments described herein are not limited in their application or use to the details of construction and arrangement of parts and steps illustrated in the drawings and description. Features of the illustrative embodiments and variants may be implemented or incorporated in other embodiments, variants, and modifications, and may be practiced or carried out in various ways. Furthermore, unless otherwise indicated, the terms and expressions employed herein have been chosen for the purpose of describing the illustrative embodiments of the present invention for the convenience of the reader and are not for the purpose of limiting the invention. Having described the invention in detail and by reference to preferred embodiments thereof, it will be apparent that modifications and variations are possible without departing from the scope of the invention which is defined in the appended claims.

What is claimed is:

1. Carbon quantum dots having selected adsorption of CO₂ over N₂ and O₂, wherein the carbon quantum dots are selected from the group consisting of amine-functionalized carbon quantum dots and nitrogen-doped carbon quantum dots.

2. The carbon quantum dots of claim 1, wherein the carbon quantum dots comprise amine-functionalized carbon quantum dots having an aromatic or synthetic hydrocarbon structure with at least two amine groups attached to the structure.

3. The carbon quantum dots of claim 2, having at least three of the amine groups attached to the structure.

4. The carbon quantum dots of claim 2, having at least four of the amine groups attached to the structure.

5. The carbon quantum dots of claim 1, wherein the carbon quantum dots comprise nitrogen-doped carbon quantum dots having an aromatic or synthetic hydrocarbon structure with at least two nitrogen atoms attached to the structure.

6. The carbon quantum dots of claim 5, having at least four of the nitrogen atoms attached to the structure.

7. The carbon quantum dots of claim 5, having at least six of the nitrogen atoms attached to the structure.

8. The carbon quantum dots of claim 5, having at least eight of the nitrogen atoms attached to the structure.

9. The carbon quantum dots of claim 1, wherein the carbon quantum dots comprise a base structure selected from the group consisting of naphthalene, phenanthrene, pyrene, anthanthrene, coronene, ovalene, and combinations thereof.

10. The carbon quantum dots of claim 1, wherein the carbon quantum dots comprise a large base structure having at least one dimension of at least about 3 nm.

11. Carbon quantum dots having selected adsorption of CO₂ over N₂ and O₂, wherein the carbon quantum dots have an aromatic or synthetic hydrocarbon base structure with at least one of a) from two to four amine groups attached to the structure, and b) from two to eight nitrogen atoms attached to the structure.

12. The carbon quantum dots of claim 11, wherein the carbon quantum dots are amine-functionalized and exhibit an adsorption selectivity of CO₂ over N₂ of about 2.0 to about 2.7.

13. The carbon quantum dots of claim 12, wherein the carbon quantum dots exhibit an adsorption selectivity of CO₂ over O₂ of about 1.8 to about 2.2.

14. The carbon quantum dots of claim 11, wherein the carbon quantum dots are nitrogen-doped and exhibit an adsorption selectivity of CO₂ over N₂ of about 1.4 to about 2.4.

15. The carbon quantum dots of claim 14, wherein the carbon quantum dots exhibit an adsorption selectivity of CO₂ over O₂ of about 1.3 to about 2.1.

16. The carbon quantum dots of claim 11, wherein the base structure is selected from the group consisting of naphthalene, phenanthrene, pyrene, anthanthrene, coronene, ovalene, and combinations thereof.

17. The carbon quantum dots of claim 11, wherein the base structure comprises a synthetic hydrocarbon structure having at least one dimension of at least about 3 nm.

18. Carbon quantum dots derived from lignin, the carbon quantum dots having selected adsorption of CO₂ over N₂ and O₂ and a base structure selected from the group consisting of naphthalene, phenanthrene, pyrene, anthanthrene, coronene, ovalene, and a synthetic hydrocarbon with a dimension of at least about 3 nm, wherein the carbon quantum dots comprise at least one of a) two or more amine groups, and b) two or more nitrogen atoms.

19. The carbon quantum dots of claim 18, wherein the carbon quantum dots are amine-modified.

20. The carbon quantum dots of claim 18, wherein the carbon quantum dots are nitrogen doped.
